(19) United States
(12) Patent Application Publication
(10) Pub. No.: US 2010/0175937 A1
(43) Pub. Date: Jul. 15, 2010

(54) Energy Coaster wheel generator

(75) Inventor: Dannell J. Davidson, Rapid City, SD (US)

Correspondence Address: Dannell Davidson, 4820 West Nike Rd., Rapid City, SD, 57701, US

(73) Assignee: Dannell James Davidson, Rapid City, SD (US)

(21) Appl. No.: 12/319,784

(22) Filed: Jan. 13, 2009

(51) Int. Cl. B60K 6/26

(52) U.S. Cl. 180/65.31; 903/906

(57) ABSTRACT

A wheel generator capable of producing a higher amount of usable energy by allowing the system to engage when the axle the unit is mounted on is accelerated. The generator harness higher amounts of usable energy by allowing the two units of the electromagnetic system to rotate in opposite directions when engaged, driven by the clutch system, while all the unit rotates on bearings with exception to the Axle Rods. When the system disengages by the spring system the Earth Magnets rotate counter clockwise of Magnetic Wires until axle resumes acceleration and clutch re-engages or entire unit looses rotational energy due to axle remaining at a constant rest for an extended period of time. This device is not claimed to be a perpetual motion device of any kind or sort.

### BACKGROUND OF THE INVENTION

1. Field of the Invention

The present invention relates to electromagnetic generators revolution of axels. More particularly it relates to the energy that can be harnessed by the forward momentum of the vehicle when accelerating and the capability of the generator to continue producing energy while the axles momentum is slowing and a reverse rotation, of the earth magnets,required for electromagnetic generators.

2. Description of the Prior Art

In recent years the demand for electric vehicles has increased. Electric vehicles with battery packs capable of storing energy to produce forward momentum have been built. Regenerative systems capable of recharging the electrical drives have been designed and implemented. A need will rise for these vehicles to be capable of harnessing all the available energy possible to increase their overall efficiencies. Axles capable of capturing wasted energy the most efficient way possible will be needed.

### SUMMARY OF THE INVENTION

It is an object of present invention to provide a regenerative system of the type in which the generator is implemented into the drive system presumably in the wheels themselves. The system includes a mechanism (clutch) that allows the Magnetic Wire assembly to engage with the forward force and momentum of the axle. The mechanism that engages the Wire will also have the capability to engage a set of gears that will move the Earth Magnets in the reverse direction of the forward moving axle. Thus in return moving the Magnetic Wire and Earth Magnets in opposite directions, increasing the attainable energy to be converted to recharge the DC battery and electrical system. The Clutch works in a revolutionary way in respect to the axle. The system has a set of bars mounted on the outside of a plate that is fixed to the revolving axle. When the axle accelerates forward in any fashion (down hills, motor, etc.) the bar asserts force on a metal insert. The metal insert slides forward freeing the range of motion of the clutch which is then sprung vertical from the tension of the spring mounted directly underneath its' lever. This engages the entire system. When the vehicle slows in any fashion the bar no longer asserts pressure on the spring sliding the metal insert back into place decreasing the range of motion of the clutch compressing the spring underneath its' lever. The vehicle would be experiencing deceleration at this point, the clutches would be disengaged. The momentum remaining in the Magnetic Wire assembly would keep the assembly spinning creating a charge, even at a dead stop. The earth magnets would continue to move in the reverse fashion until the potential energy from their momentum equals zero. The entire system uses a series of ball bearings to allow certain functions of certain parts at a given duration of the units operation. The assembly can be mounted on any system where the energy is needing to be harnessed in a higher efficiency application then current system. All materials of unit are nonmagnetic conductive materials in exception of the magnetic wire, springs and earth magnets.

### BRIEF DESCRIPTION OF THE DRAWINGS

The description of the following along with detailed drawings of the assembly will provide a fuller understanding of the device and the functions entailed.

FIG. 1 is a perspective view of the assembly cutaway at the center. It is a straight look into the assembly for a better view of the parts.

FIG. 2 is a perspective cutaway view of the assembly from an angular view giving better insight on the assembly.

FIG. 3 is a side view of the clutch system used for engaging the drives.

### DETAILED DESCRIPTION OF THE PREFERRED EMBODIMENT

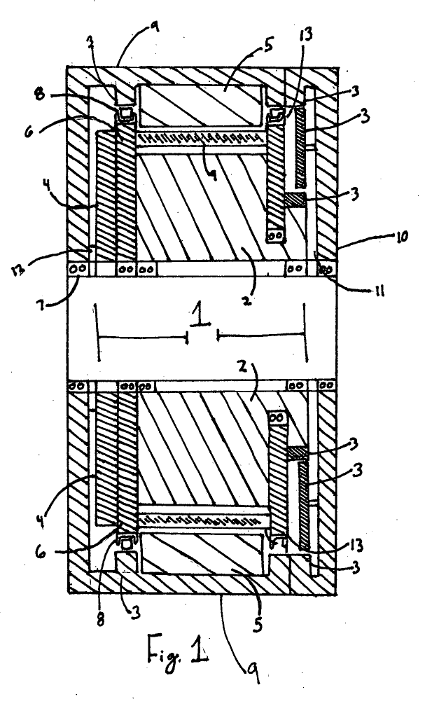

Referring now to FIG. 1 where the entire assembly is shown at a straight view and cutaway at length and vertical. Axle 1 serves as the drive system. The energy from the rotational force of the Axle 1 is harnessed by Earth Magnets 2 and Magnetic Wire 5. When the Axle 1 accelerates the only part of the assembly that initially moves at the same rate are the Axle Rod 4 assembly that is fixed to the axle.

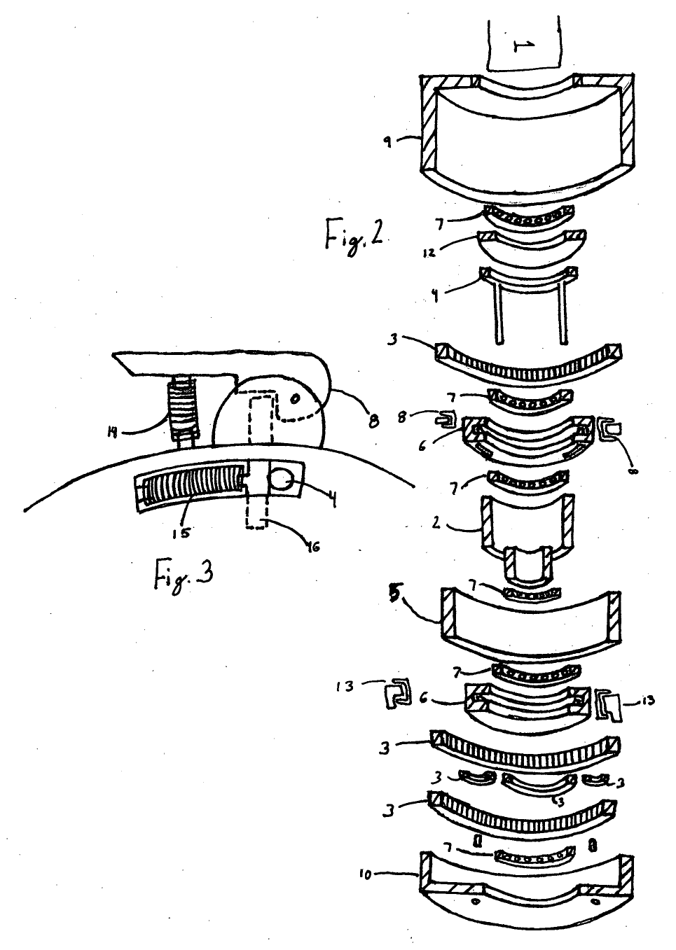

Referring to FIG. 3 when the Axle Rod 4 assembly that is fixed to FIG. 2 Axle 1 moves forward with FIG. 2 Axle 1, Axle Rod 4 assembly asserts force on Metal Insert 16. This force compresses Spring 15 freeing range of movement of Clutch 8. The range of movement allows Spring 14 to decompress and Clutch 13 Engages the FIG. 2 Gears 3.

Referring to FIG. 2 with Clutch 8 engaged the entire system begins operating. The Magnetic Wire 9 assembly begins to rotate at same rate of speed as FIG. 1 Axle 1. All Gears 3 are then rotating. Gears 3 attached to Earth Magnets 2 assembly rotate in such a manner that Earth Magnets 2 rotate counterclockwise of Axle 1. This in turn creates a higher amount of electric energy from the generator.

Referring to FIG. 1 when Axle 1 slows in any manner relative to when Axle 1 were accelerating, Axle Rods 4 decrease their force on FIG. 3 Metal Insert 16. Spring 15 then decompresses and compresses Spring 14 by restricting the range of motion of Clutch 8.

Referring to FIG. 1 with Clutch 8 disengaged Magnetic Wire 5 assembly connected to Magnetic Wire 9 assembly mounted on Bearings 7 retains the forward momentum of Axle 1 and continues to rotate forwards unless Axle 1 is at rest until Magnetic Wire 5 and Magnetic Wire 9 assembly loose forward momentum. Magnetic Wire 9 assembly connected to Gears 3 will continue to rotate until Axle 1 has been at rest for appropriate duration of time. When Axle 1 accelerates the system repeats.

Referring to FIG. 1 The entire assembly is mounted on Bearings 7 with the exception of Spacer 12 and Axle Rods 4 which are mounted directly to the axle.

### KEY

1. Axel
2. Earth Magnets
3. Gears
4. Axle Rod
5. Magnetic Wire
6. Clutch Housing
7. Bearings
8. Clutch
9. Magnetic Wire Assembly
10. Earth Magnet Assembly
11. Space
12. Spacer
13. Clutch
14. Spring
15. Spring
16. Metal Insert

What I claim as my invention is:

1.) A electromagnetic generator using a clutch system to engage.

2.) The claim 1 electromagnetic generator capable of using said engagement system to allow the assembly to rotate in a said free motion when said axle is decelerated and engaged when said axle is accelerated using system of said free motion bearings.

3.) A gear assembly capable of independently rotating the two parts of electromagnetic assembly.

4.) The claim 3 electromagnetic assembly in said system capable of independently rotating the two electromagnetic units (said Wire and said Magnets) is opposite directions in said type of unit arranged for use with axle driven units or devices using said system of gears allowing this said function.

5.) Clutch system using axle force to engage spring actuated clutch system.

6.) The claim 5 said clutch unit capable of engagement by said process of using said springs that allows unit to operate by said spring tension of force of axle actuating the clutch for engagement of entire unit, and said system of axle force decreasing when axle decelerates increasing spring tension on said metal insert compressing clutch spring, disengaging said system of rotating electromagnetic units in said system.

7.) System that incorporates said claims above.

8.) Said system of the said claims above incorporating the said function to act as said free moving generator device.
